(19) United States
(12) Patent Application Publication
(10) Pub. No.: US 2025/0131575 A1
(43) Pub. Date: Apr. 24, 2025

(54) IMAGE PROCESSING APPARATUS AND CONTROL METHOD FOR IMAGE PROCESSING APPARATUS

(71) Applicant: SHARP KABUSHIKI KAISHA, Sakai City (JP)

(72) Inventor: AKIHITO YOSHIDA, Sakai City (JP)

(21) Appl. No.: 18/920,073

(22) Filed: Oct. 18, 2024

(30) Foreign Application Priority Data
Oct. 23, 2023 (JP) 2023-181868

(51) Int. Cl. G06T 7/13; G06T 7/194; G06V 10/44

(52) U.S. Cl. CPC G06T 7/13; G06T 7/194; G06V 10/44

(57) ABSTRACT

An image processing apparatus and the like are provided. The image processing apparatus obtains an image that is obtained by reading a document, extracts a feature point from the image, identifies a plurality of feature points arranged in a predetermined direction in the image as feature points that correspond to an edge defining a range of the document, sets an area outside the range of the document on the basis of the identified feature points, and removes the feature points in the set area. In this way, a document area can be identified with a high degree of accuracy.

### BACKGROUND OF THE INVENTION

### Field of the Invention

The present disclosure relates to an image processing apparatus and the like. The present application is based on Japanese Patent Application No. 2023-181868 filed in Japan on Oct. 23, 2023, and the entire content thereof is included in the present application.

### Description of the Background Art

In general, in an image processing apparatus such as a flatbed scanner or a multifunction peripheral (MFP, multi-function printer), an image is generated when an image sensor captures an image of a document in a state where the document is placed on a reading surface of a document table and the document and the reading surface are covered with a document cover. At this time, the image sensor outputs an image that includes not only the document but also an inner surface of the document cover as a background. Thus, in order to generate the image of the document, it is necessary to identify a range of the document from the output of the image sensor.

In relation to the present disclosure, such a technique has been known that extracts an edge of the document by executing binarization processing using first and second threshold determination values. In addition, the following technique has been known. In the technique, a first boundary point group is extracted by sampling an edge detection result in a first direction at every first interval, a second boundary point group is extracted by sampling the edge detection result in the first direction at every second interval, a noise removal condition is determined on the basis of the first boundary point group, and then a boundary point that satisfies the noise removal condition is removed as noise from the second boundary point group.

An object to be achieved by the present disclosure is to provide an image processing apparatus capable of identifying a document area with a high degree of accuracy.

### SUMMARY OF THE INVENTION

The present disclosure provides an image processing apparatus, etc. that includes a controller. The controller obtains an image that is obtained by reading a document, extracts a feature point from the image, identifies a plurality of feature points arranged in a predetermined direction in the image as feature points that correspond to an edge defining a range of the document, sets an area outside the range of the document on the basis of the identified feature points, and removes the feature points in the area.

In addition, the present disclosure provides a control method for an image processing apparatus. The control method for the image processing apparatus includes: obtaining an image that is obtained by reading a document; extracting a feature point from the image; identifying a plurality of feature points arranged in a predetermined direction in the image as feature points that correspond to an edge defining a range of the document; setting an area outside the range of the document on the basis of the identified feature points; and removing the feature points in the area.

The present disclosure can provide the image processing apparatus capable of identifying a document area with a high degree of accuracy.

### BRIEF DESCRIPTION OF THE DRAWINGS

FIG. 1 is a view illustrating an example of a document, an image of which is captured by an image processing apparatus.

FIG. 2A illustrates an example of an image that is generated by capturing an image of the document using a gray background and in which feature points are extracted, and FIG. 2B illustrates an example of an image that is generated by capturing an image of the document using a white background and in which the feature points are extracted.

FIG. 3 is a block diagram of the image processing apparatus according to a first embodiment of the present disclosure.

FIG. 4 is a view illustrating an example of the document, the image of which is captured by the image processing apparatus according to the first embodiment.

FIG. 5 is a view illustrating an original image that is generated when the image processing apparatus according to the first embodiment captures the image of the document and the feature points that are extracted by executing feature point extraction processing on the original image.

FIG. 6 is a view illustrating identification of a document outside range by the image processing apparatus according to the first embodiment on the basis of a side of the document image in a sub-scanning direction.

FIG. 7 is a view illustrating the original image after the image processing apparatus according to the first embodiment deletes pixels in a document outside area.

FIG. 8 is a view illustrating identification of the document outside range by the image processing apparatus according to the first embodiment on the basis of a side of a tilted document image in the sub-scanning direction.

FIG. 9 is a flowchart illustrating action of the image processing apparatus according to an example of the first embodiment.

FIG. 10 is a flowchart illustrating removal of unnecessary edge information in the action of the image processing apparatus according to the example of the first embodiment.

FIG. 11A is an example of the original image, and FIG. 11B is an example after gradation correction.

FIG. 12A illustrates an example after scaling, and FIG. 12B illustrates an example after filter processing of an edge in a horizontal direction.

FIG. 13A illustrates an example after the filter processing is executed on an edge in a vertical direction, and FIG. 13B illustrates an example after the edge in the horizontal direction is detected.

FIG. 14A illustrates an example after the edge in the vertical direction is detected, and FIG. 14B illustrates an example after noise in the horizontal direction is removed.

FIG. 15A illustrates an example after noise in the vertical direction is removed, and FIG. 15B illustrates an example after a contour edge in the horizontal direction is extracted.

FIG. 16A illustrates an example after a contour edge in the vertical direction is extracted, and FIG. 16B illustrates an example in which the contour edges in the horizontal direction and the vertical direction are combined.

FIG. 17 is a view illustrating a shape of a document that is used in a second embodiment of the present disclosure.

FIG. 18A is a view illustrating outsides-of-a-document-range, which are determined by using a method in the first embodiment, in the original image generated by capturing the image of the document in FIG. 17, and FIG. 18B is a view illustrating a state where the unnecessary edge information in the first embodiment is removed from the original image in FIG. 18A.

FIG. 19A is a view illustrating outsides-of-the-document-range, which are determined by using a method in the second embodiment, in the original image generated by capturing the image of the document in FIG. 17, and FIG. 19B is a view illustrating the state where unnecessary edge information in the second embodiment is removed from the original image in FIG. 19A.

FIG. 20A illustrates the original image, tilting of which is detected in step S15 of FIG. 9, and an example of the feature points extracted from the original image, FIG. 20B illustrates a state where the original image and the feature points in FIG. 20A are subjected to tilt correction of the edge information in step S17, and FIG. 20C illustrates an example of a histogram of a vertical edge that is generated on the basis of the feature points in FIG. 20B, which have been subjected to tilt correction of the edge information.

FIG. 21A illustrates the original image, the tilt of which is detected in step S15 of FIG. 9, and the example of the feature points extracted from the original image, FIG. 21B illustrates counting of a frequency without performing the tilt correction of the feature points in FIG. 21A, and FIG. 21C illustrates an example of a histogram of the vertical edge that is generated by counting the frequency as in FIG. 21B.

### DESCRIPTION OF THE PREFERRED EMBODIMENTS

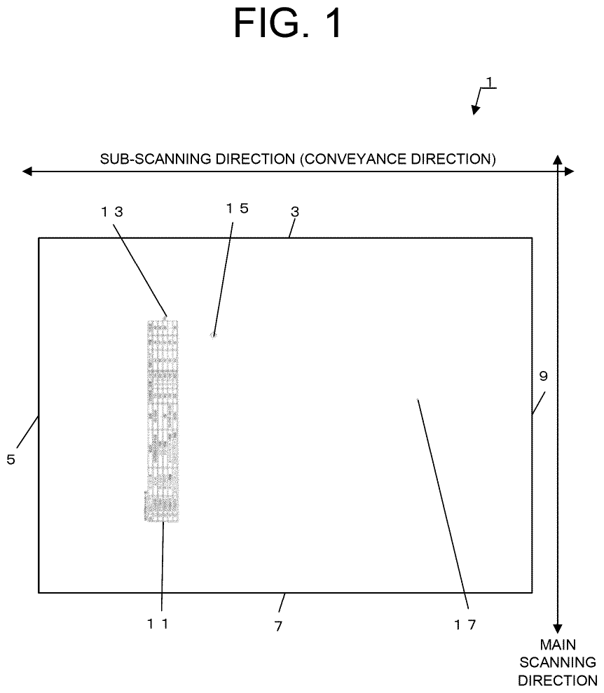

Prior to the description of embodiments, a relationship between a difference in background color and a feature point of a detected edge will be described. FIG. 1 is a view illustrating a document 1 as an example of a document, an image of which is captured by an image processing apparatus. Here, the image processing apparatus includes a line image sensor in which imaging elements are arranged along a main scanning direction. Hereinafter, in the present specification, the feature point is a pixel that is extracted as a side of an outer periphery of the document (or an edge of the document) from an image including the document 1, and is expressed by coordinates of the feature point. Feature point extraction processing is processing to extract the feature point from the image. In the feature point extraction processing, for example, a sub-scanning direction is set as an X-axis, the main scanning direction is set as a Y-axis, a pixel having a maximum value of X and a pixel having a minimum value of X are extracted as the feature points on each straight line that passes through the image and is parallel to the X-axis, and coordinates of those feature points are output. In addition, a pixel having a maximum value of Y and a pixel having a minimum value of Y are extracted as the feature points on each straight line that passes through the image and is parallel to the Y-axis, and coordinates of those feature points are output.

The document 1 is a rectangular piece of paper that has sides 3, 5, 7, 9. A table 11 is provided in the document 1. Stains 13, 15, 17 adhere to the document 1. As illustrated in FIG. 1, long sides of the document 1 are arranged along the sub-scanning direction (a document conveyance direction) of the image processing apparatus, and short sides thereof are arranged along the main scanning direction (a direction orthogonal to the document conveyance direction) of the image processing apparatus.

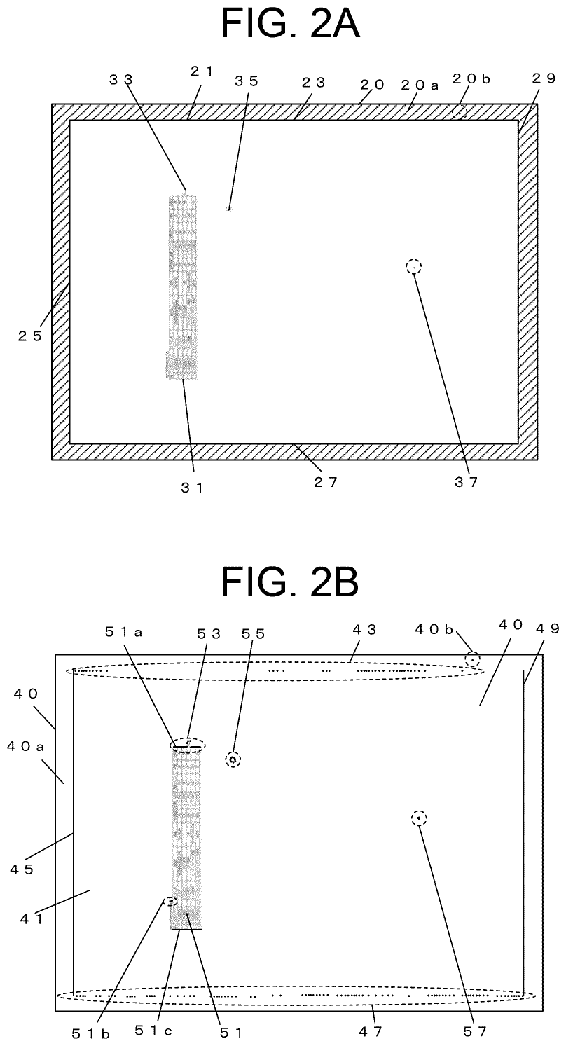

FIG. 2A illustrates an example of an image that is generated by capturing an image of the document using a gray background. An original image 20 includes a gray background 20a and a document image 21. The gray background 20a is a background image and has a stain 20b. The stain 20b corresponds to a stain that has adhered to the gray background 20a or an optical system that has generated the original image 20, and is irrelevant to the document 1. The document image 21 is an image that corresponds to the document 1. The document image 21 has sides 23, 25, 27, 29, a table 31, stains 33, 35, 37 that respectively correspond to the sides 3, 5, 7, 9, the table 11, and the stains 13, 15, 17 of the document 1.

Here, it is considered to execute the feature point extraction processing on the original image 20. In the original image 20, since the gray background 20a and the document image 21, which is the image of the document 1 drawn on a piece of white paper, are in mutually different colors, a boundary portion between the gray background 20a and the piece of the white paper is extracted as a prominent feature point. When the feature point extraction processing is executed in a manner to only extract such a prominent feature point and not to extract a subtle feature point, the subtle feature point that is derived from the stain or the like is not extracted. As a result, when the feature points are extracted from the original image 20, the sides 3, 5, 7, 9 are extracted almost as they are as the sides 23, 25, 27, 29. Accordingly, each of the sides 23, 25, 27, 29 can easily be detected as the boundary between the gray background 20a and the document image 21. At this time, since the stain 20b in the gray background 20a is not extracted or is extracted as the subtle feature point, the stain 20b hardly affects detection of the sides 23, 25, 27, 29.

Just as described, when the image of the document using the piece of the white paper is generated, use of the gray background facilitates extraction of the feature points that correspond to the sides of the document. Thus, the gray background is suitable for use in identification of a document area. However, in the case where an image, a document area of which does not have to be identified, is generated, the gray background has problems as follows. Pieces of the white paper include a piece that is punched, a piece that is punched like a loose leaf, and a piece with rounded corners, that is, subjected to so-called corner rounding processing. When the image of the document on any of these pieces of the white paper is generated by using the gray background, such a document image is generated that includes the gray background exposed from a hole portion or a portion subjected to the corner rounding processing. The thus-exposed gray background is irrelevant to a content of the document provided on the piece of the white paper, and thus is preferably not included in the document image. As a method for avoiding this problem, it is considered to use the gray background when the document area has to be identified at the time of generating the document image, and to use a white background when it is unnecessary to identify the document area at the time. However, this method requires a configuration capable of switching between the gray background and the white background, and raises problems of a complicated configuration of the apparatus and cost increase. In view of such a circumstance, an object of the present disclosure is to provide image processing capable of identifying the document area with a high degree of accuracy even when the white background is used.

FIG. 2B illustrates an example of an image that is generated by capturing an image of the document using the white background. An original image 40 includes a white background 40a and a document image 41. The white background 40a is a background image and has a stain 40b. The stain 40b corresponds to a stain that has adhered to the white background 40a, the optical system that has been used to generate the original image 40, or the like. The document image 41 is an image that corresponds to the document 1. The document image 41 has pixel groups 43, 45, 47, 49, a table 51, stains 53, 55, 57 that respectively correspond to the sides 3, 5, 7, 9, the table 11, and the stains 13, 15, 17 of the document 1.

In the original image 40, the document 1 is provided on the piece of the white paper. Thus, when a boundary between the document image 41 as the image thereof and the white background 40a, that is, feature points that correspond to the sides of the document 1 are detected, not only the prominent feature points but also the subtle feature points have to be extracted. The thus-extracted feature points include the feature points that correspond to the sides and the feature points that correspond to the stains. Such a feature point that corresponds to the stain, in particular, the feature point that corresponds to a stain outside the document, such as the stain 40b, causes erroneous detection of the side of the document 1.

When the feature point extraction processing is executed on the document image 41, the pixels that correspond to the sides 5, 9 are extracted almost as they are as the pixel groups 45, 49. Meanwhile, the pixels that correspond to the sides 3, 7 include the pixels that are extracted as the feature points and the pixels that are not extracted as the feature points. The pixels that are correctly extracted as the pixels corresponding to the side 3 are the pixel group 43. The pixels that are erroneously extracted are: a pixel group 51a as a frame line on an upper side of the table 51; a pixel group 51b as a part of the frame line of the table 51; the stain 53; pixels in the upper half of the stains 55, 57; and the stain 40b. Similarly, the pixels that are correctly extracted as the pixels corresponding to the side 7 are the pixel group 47. The pixels that are erroneously extracted are: a pixel group 51c as the frame line on a lower side of the table 51; and pixels in the lower half of the stains 55, 57.

As described above, when the image of the document is generated by using the white background, and the feature point extraction processing is executed thereon, extraction accuracy of the feature points varies by the direction of the side to be extracted. General image forming apparatuses (MFP) including an image processing apparatus 60 described below includes a line image sensor and a light source element group. The line image sensor includes plural imaging elements that are arranged along the main scanning direction (or a first straight line). The light source element group includes plural light source elements that are arranged along the sub-scanning direction (or a second straight line that is orthogonal to the first straight line). Thus, the sides 5, 9 in the main scanning direction (a direction along the line image sensor) are obliquely irradiated with light. The corresponding feature points tend to be accurately extracted from the thus-generated images of the sides 5, 9. Meanwhile, the sides 3, 7 in the sub-scanning direction are irradiated with light from substantially right above. It tends to be difficult to extract the corresponding feature points from the thus-generated images of the sides 3, 7. In addition, in regard to the sides 3, 7 in the sub-scanning direction, images other than the sides 3, 7 tend to be erroneously extracted as the feature points that correspond to the sides 3, 7. The images that are erroneously detected as the feature points include images of objects drawn in the document, such as parts (the pixel groups 51a, 51c) of the table 51, the stains (53, 55, 57) in the document, and the stain 40b outside the document.

In the present disclosure, the feature point that is erroneously extracted from the outside of a document range is removed on the basis of the feature points that correspond to the side in the main scanning direction, from which the feature points can be extracted with the higher degree of the accuracy, thereby improving detection accuracy of the document range to be subsequently detected on the basis of the feature points.

### 1. First Embodiment

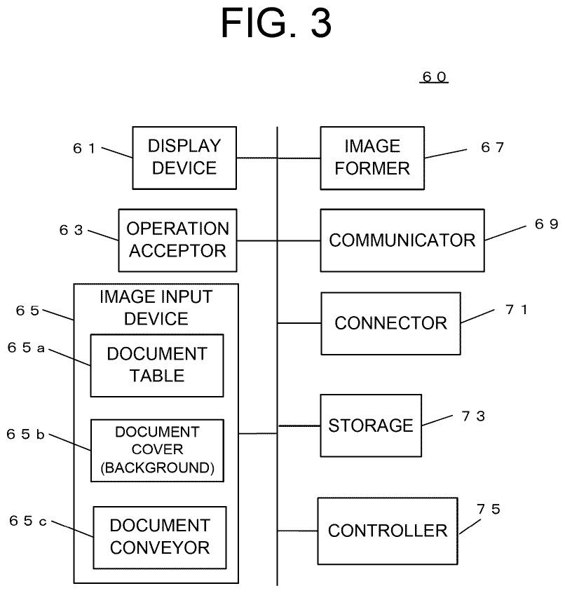

FIG. 3 is a block diagram of an image processing apparatus according to a first embodiment of the present disclosure. The image processing apparatus 60 is a multifunction peripheral, a multi-function printer (MFP), or scanner, for example. The image processing apparatus 60 includes a display device 61, an operation acceptor 63, an image input device 65, an image former 67, a communicator 69, a connector 71, a storage 73, and a controller 75.

The display device 61 displays images and characters. For example, the display device 61 is configured by a liquid crystal display (LCD), an organic electro-luminescence (EL) panel, or the like. The display device 61 may be a single display device or may further include an externally-connected display device.

The operation acceptor 63 accepts an operation input from a user. The operation acceptor 63 is configured by hardware keys or software keys, for example. The operation acceptor 63 includes task keys for performing tasks, such as FAX transmission and image reading, a stop key for stopping an operation, and the like. The operation acceptor 63 may also include physical operation keys, such as a task key, a stop key, a power key, and a power saving key.

The image input device 65 reads the image (the document) and outputs the read image as image data. The image input device 65 is configured by a common scanner (image input device). The scanner may be a flatbed scanner or a sheet-through scanner. The image input device 65 may input the image data from an external storage medium such as USB memory, or may receive the image via a network. The image input device 65 includes a document table 65a, a document cover 65b, and a document conveyor 65c. The image input device 65 includes a line image sensor and a light source element group. The line image sensor includes plural imaging elements that are arranged along the main scanning direction (or the first straight line). The light source element group includes plural light source elements that are arranged along the sub-scanning direction (or the second straight line that is orthogonal to the first straight line).

The document table 65a is a table on which the document is placed when the image thereof is captured. The document table 65a includes: a glass plate (not illustrated) on which the document is placed; and the line image sensor (not illustrated) under the glass plate. The document is placed such that a surface to be read faces the glass plate. The line image sensor is a sensor in which the plural imaging elements are arranged linearly. The line image sensor is arranged along a side of the glass plate. A longitudinal direction of the line image sensor is the main scanning direction. A direction that is orthogonal to the longitudinal direction of the line image sensor is the sub-scanning direction.

The document cover 65b is a cover that covers the glass plate and the document after the document is placed on the document table 65a. The line image sensor captures the image of the document in a closed state of the document cover 65b. Thus, when the image of the document is captured, the document cover 65b becomes the background of the document. For this reason, the document cover 65b is also referred to as a background portion. The background portion of the document cover 65b is white.

The document conveyor 65c is a so-called document feeder and conveys the document to a position between the document cover 65b and the glass plate of the document table 65a before the line image sensor captures the image of the document in the closed state of the document cover 65b. In addition, the document conveyor 65c discharges the document, the image of which has been captured, from the position between the document cover 65b and the glass plate of the document table 65a. The document conveyor 65c conveys the document along the sub-scanning direction of the line image sensor. The document conveyor 65c may have another configuration. For example, in the case where the scanner of the image input device 65 is the sheet-through scanner, the document conveyor 65c may be a document conveyor that sequentially conveys sheets to be scanned by using a conveyance roller or the like and causes the line image sensor to read the sheets.

The image former 67 forms (prints) the image on a medium such as a copy sheet on the basis of the image data. The image former 67 adopts any appropriate printing method, and may be any of an inkjet printer, a laser printer, a thermal transfer printer, and the like, for example. The image former 67 may be a monochrome printer or a color printer. The image former 67 may include a paper feed mechanism that supplies the medium, a conveyor mechanism that conveys the medium, a sorter mechanism that sorts the medium after the image is formed, and the like.

The communicator 69 is connected to the network. For example, the communicator 69 is configured by an interface that is connectable to a wired local area network (LAN), a wireless LAN, or a Long Term Evolution (LTE) network. When being connected to the network, the communicator 69 is connected to another device or an external network. In addition to the above, the communicator 69 may be an interface that makes short-range wireless communication, such as near field communication (NFC) or Bluetooth®.

The connector 71 connects the image processing apparatus 60 to another device. For example, the connector 71 is a USB interface, to which the USB memory or the like is connected. Alternatively, the connector 71 may be an interface, such as an HDMI®, instead of the USB interface.

The storage 73 stores various programs required for action of the image processing apparatus 60, and stores various data. The storage 73 includes a recording device that enables transitory storage, such as dynamic random access memory (DRAM), or a non-transitory recording device, such as a solid state drive (SSD) including semiconductor memory or a hard disk drive (HDD) including a magnetic disc. The storage 73 is configured as a single component for convenience of description. However, the storage 73 may be configured as separate components for purposes of serving as an area (a primary storage area) used for program execution, an area (an auxiliary storage area) for saving the programs and the data, an area used for caching, and the like.

The controller 75 controls the entire image processing apparatus 60. The controller 75 includes one or plural control devices or control circuits, and, for example, includes a central processing unit (CPU), a system on a chip (SoC), and the like. In addition, the controller 75 can implement each function by reading the program, which is stored in the storage 73, and executing the processing.

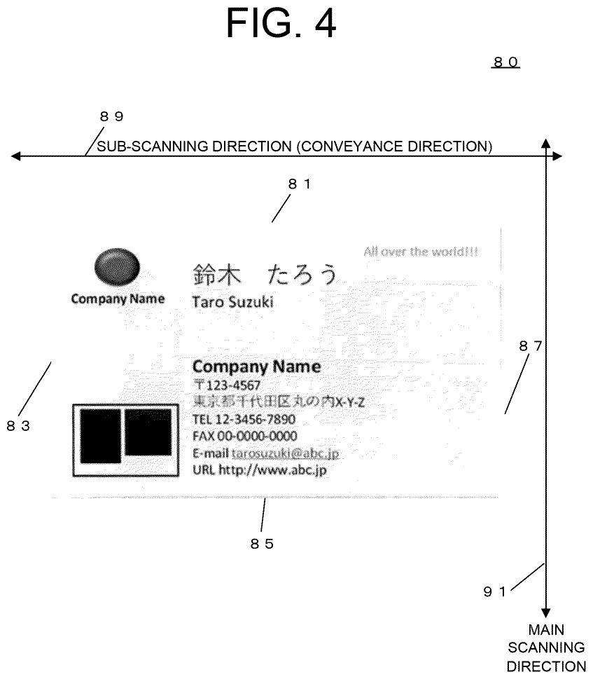

FIG. 4 is a view illustrating an example of the document, the image of which is captured by the image processing apparatus 60 according to the first embodiment. A document 80 is a rectangular medium (for example, an A-size or B-size copy sheet or the like) on which contents of the document such as characters, a symbol, a figure, and an image are drawn, and is a business card in this case. The document 80 has sides 81, 83, 85, 87. The image processing apparatus 60 generates the image with a longitudinal direction 89 as the sub-scanning direction (the conveyance direction) and a short direction 91 as the main scanning direction. FIG. 4 illustrates an image of the document 80, and the image includes a company logo and a company name at an upper left corner. Names in Japanese and English are provided on a right side of the company logo. The name, a zip code, an address, a telephone number, a facsimile number, an e-mail address, and a URL address of a WEB site of the company are provided in a lower central portion of the business card. These pieces of the information are imaged examples. The text in Japanese and the text in English co-exist, but the languages are not particularly identified. Thus, in the present embodiment, these are described as the images of the document 80, and the information and the characters themselves included in these images are not identified. Hereinafter, in the present specification and the drawings, the same applies to the document 80 and the images obtained by subjecting the document 80 to image processing.

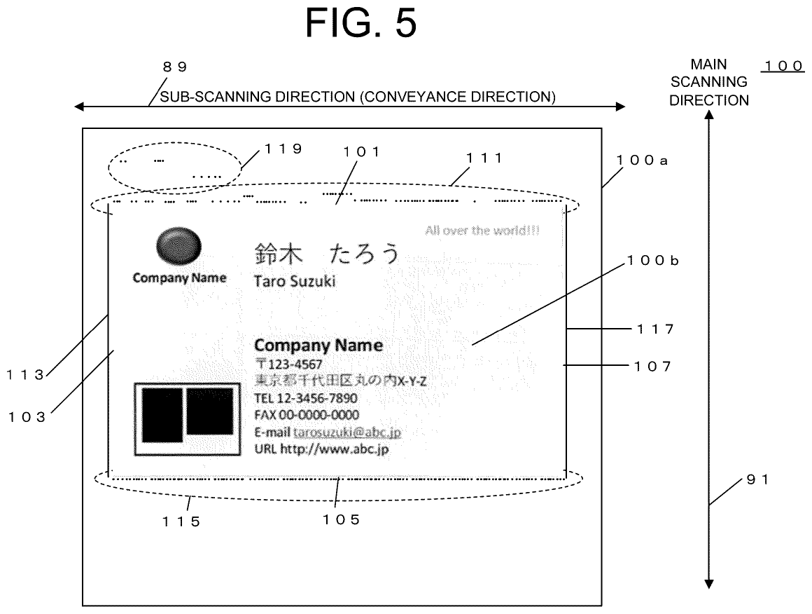

FIG. 5 is a view illustrating: an original image that is generated when the image processing apparatus 60 according to the first embodiment captures the image of the document 80; and the feature points that are extracted by executing the feature point extraction processing on the original image. An original image 100 includes a white background 100a and a document image 100b. The white background 100a corresponds to the background of the document cover 65b. The document image 100b is an image that corresponds to the document 80, and has edges 101, 103, 105, 107 that respectively correspond to the sides 81, 83, 85, 87 of the document 80. A feature point group 111 is a set of feature points that are extracted from the edge 101. A feature point group 113 is a set of feature points that are extracted from the edge 103. A feature point group 115 is a set of feature points that are extracted from the edge 105. A feature point group 117 is a set of feature points that are extracted from the edge 107. A feature point group 119 is a set of feature points that are obtained by erroneously extracting noise (for example, the stain adhering to the white background 100a or the optical system of the image input device 65) generated at the time of imaging by the image input device 65, and does not correspond to the document 80.

For convenience of drawing, the feature point groups 111, 113, 115, 117 are respectively drawn on outer sides of the edges 101, 103, 105, 107, but, in reality, substantially overlap sides of an outer periphery at the edges 101, 103, 105, 107.

As described above, the feature point that corresponds to the side along the main scanning direction is extracted with the higher degree of accuracy than the feature point that correspond to the side along the sub-scanning direction. Thus, the pixels that correspond to the sides along the main scanning direction are extracted as the feature point groups 113, 117, each of which is arranged in a continuous straight line. Meanwhile, the pixels that correspond to the sides along the sub-scanning direction are not extracted as the continuous straight lines. The feature point groups 111, 115 that are respectively extracted from the edges 101, 105 are each extracted as a set of discontinuous points. In particular, the entire feature point group 111 is not on one straight line, and is partially extracted at positions shifted from the straight line. In addition, the feature point group 119 is erroneously extracted as the feature points that correspond to the edge 101.

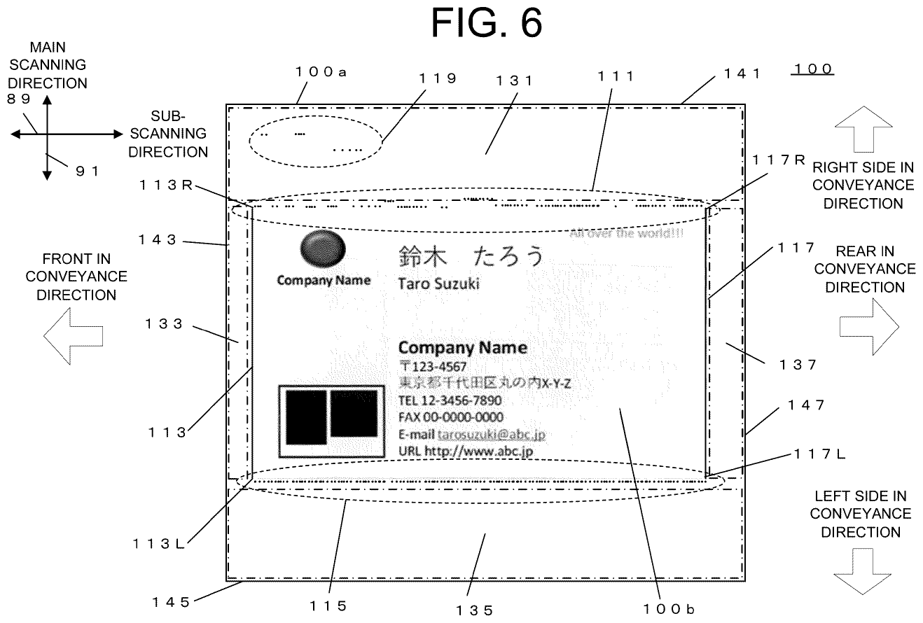

FIG. 6 is a view illustrating identification of an area outside the document range (hereinafter referred to as an outside-of-the-document-range) by the image processing apparatus 60 according to the first embodiment on the basis of the side in the main scanning direction of the document image 100b. The controller 75 only uses the feature point groups 113, 117 in the main scanning direction to identify outsides-of-the-document-range 131, 133, 135, 137 as follows, for example. That is, each of the feature point groups 113, 117 is extracted as the feature points that correspond to a part of the edge defining the document range. The feature point groups 113, 117 include the feature points that correspond to the two sides substantially parallel to the main scanning direction of the document 80. The outsides-of-the-document-range are identified on the basis of the feature point groups 113, 117. Sides 141, 143, 145, 147 are sides that define an outer periphery of the original image 100.

The controller 75 determines, as the outside-of-the-document-range 131, a straight line that connects end points 113R, 117R on a right side in the conveyance direction of the feature point groups 113, 117 and a rectangular area, which is located on the right side of this straight line in the conveyance direction, in the original image 100.

The controller 75 determines, as the outside-of-the-document-range 133, the feature point group 113 and a rectangular area, which is located in front of the feature point group 113 in the conveyance direction, in the original image 100.

The controller 75 determines, as the outside-of-the-document-range 135, a straight line that connects end points 113L, 117L on a left side in the conveyance direction of the feature point groups 113, 117 and a rectangular area, which is located on the left side of this straight line in the conveyance direction, in the original image 100.

The controller 75 determines, as the outside-of-the-document-range 137, the feature point group 117 and a rectangular area, which is located behind the feature point group 117 in the conveyance direction, in the original image 100. The outsides-of-the-document-range 131, 133, 135, 137 are determined as described so far. It should be noted that the feature point groups 111, 115 are not used for these determinations. Only the feature point groups 113, 117 with a high degree of detection accuracy in the main scanning direction are used to determine the outsides-of-the-document-range 131, 133, 135, 137.

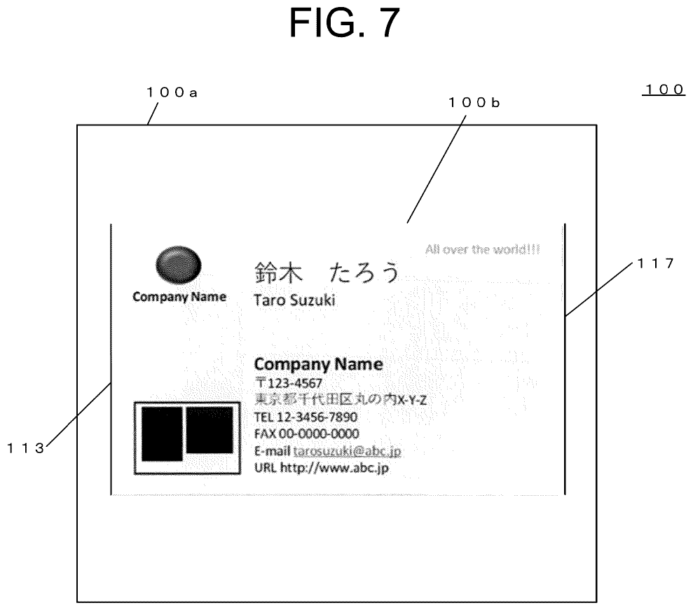

FIG. 7 is a view illustrating the original image after the image processing apparatus 60 according to the first embodiment deletes pixels in the outsides-of-the-document-range 131, 133, 135, 137. Compared to FIG. 6, the feature point groups 111, 115, 119 are deleted.

The controller 75 executes general processing to identify the document range on the basis of the original image 100, from which the pixels on the outsides-of-the-document-range 131, 133, 135, 137 have been deleted as illustrated in FIG. 7. According to such a first embodiment, the document range is detected after the pixels on the outsides-of-the-document-range are removed as the noise in advance. Thus, the document range can be detected further accurately without being affected by the noise in the outsides-of-the-document-range.

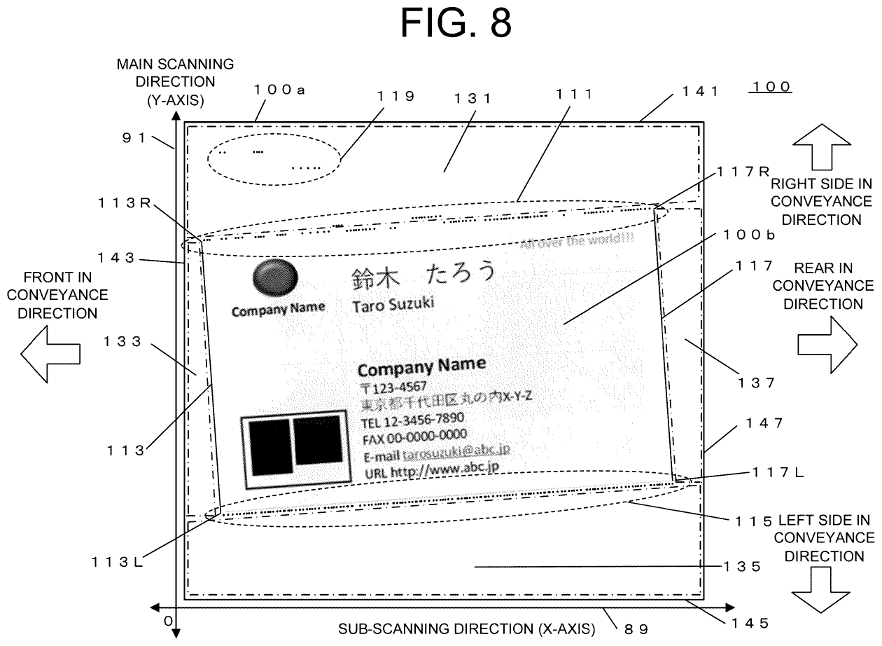

FIG. 8 is a view that corresponds to FIG. 6 and illustrates identification of the outside-of-the-document-range by the image processing apparatus 60 according to the first embodiment on the basis of the side in the main scanning direction of the tilted document image 100b. For example, there is a case where, when the user places the document on the document table 65a, the document is arranged such that each of the sides of the document is tilted with respect to the main scanning direction/the sub-scanning direction, or the document image 100b is generated in a tilted state of the document due to a defect of the document conveyor 65c. Even in such a case, the outside-of-the-document-range is identified as follows.

The feature point groups 113, 117 are extracted as the feature points that correspond to the parts of the edge defining the document range. The feature point groups 113, 117 include the feature points that correspond to the two sides substantially parallel to the main scanning direction of the document 80. In a case of FIG. 8, the straight lines defined by the feature point groups 113, 117 are obliquely tilted. However, even in such a case, for example, the feature points that correspond to the two sides substantially parallel to the main scanning direction of the document 80 are extracted as follows. A lower left corner of the original image 100 in FIG. 8 is set as an origin, the sub-scanning direction is set as the X-axis, and the main-scanning direction is set as the Y-axis. In this case, a straight line that passes through a point (a, 0) on the X-axis and has a tilt angle θ is considered, and a straight line group that includes straight lines with slightly changed a and θ is considered. On a front side in the sub-scanning direction (the conveyance direction) of the original image 100, a straight line having the largest number of matching feature points is extracted from the straight line group, and the feature points that match the straight line are extracted as the feature points that correspond to the side on the front side in the conveyance direction of the two sides of the document 80 substantially parallel to the main scanning direction. Similarly, of the two sides of the document 80 substantially parallel to the main scanning direction, the feature points that correspond to the side on the rear side in the conveyance direction are extracted. Then, an area other than a rectangular area having the end points 113L, 113R, 117L, 117R of the feature point groups 113, 117 as vertices is identified as the outside-of-the-document-range.

### EXAMPLE

A description will be made on an example of the first embodiment. In the present example, in addition to execution of general document range detection processing, the pixels on the outside-of-the-document, which have been described in the first embodiment, are deleted.

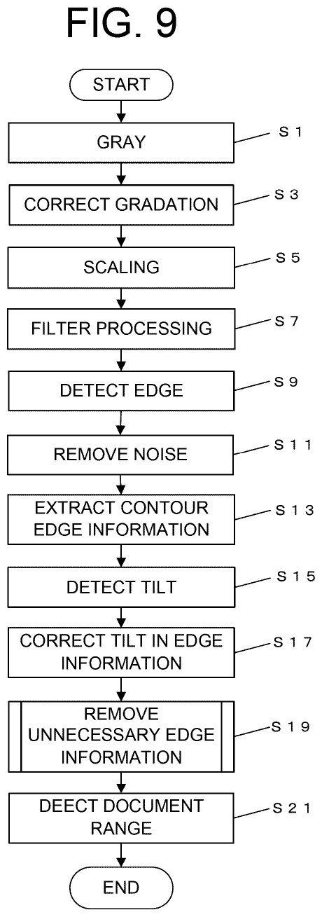

FIG. 9 is a flowchart illustrating the action of the image processing apparatus 60 according to the first embodiment.

The controller 75 reads the document by using the image input device 65, generates the original image including the white background, and grays the original image (step S1). A color image is converted to a gray scale image. The conversion method is not particularly limited to a specific conversion method. For example, the color image is converted by adding RGB signals at a ratio of 3:6:1. In this case, when a red (R) signal is set as Rx, a green (G) signal is set as Gx, and a blue (B) signal is set as Bx, a grayed signal G is expressed as G=R×0.3+G×0.6+B×0.1.

Next, the controller 75 corrects gradation of the original image that has been grayed in step S1 (step S3). Here, the gradation correction is performed to facilitate detection of the sides of the document. A gradation correction curve used for the correction is not particularly limited, but has to be a gradation correction curve that does not reduce the number of gradations in portions corresponding to the white background and the piece of the white paper of the document.

Next, the controller 75 scales the original image that has been subjected to the gradation correction in step S3 (step S5). In order to achieve both of the desired detection accuracy and a desired processing time, the scaling is preferably reduction processing to approximately 75 dpi, but is not limited to this reduction ratio.

Next, the controller 75 executes filtering processing on the original image that has been scaled in step S3 (step S7). In the present embodiment, for a purpose of reducing the influence of the noise, such filter processing that does not easily erase features of the sides of the document is executed. More specifically, the filter processing in which smoothing processing is only executed in a vertical direction or a horizontal direction is applied. However, the present disclosure is not limited to the processing using such a filter.

Next, the controller 75 detects the edges of the original image that has been subjected to the filter processing in step S7 (step S9). In the present embodiment, a portion in which an absolute value of a difference between pixel values of the adjacent pixels exceeds a predetermined value is detected as the edge. However, the present disclosure is not limited to such an edge detection method.

Next, the controller 75 removes the noise from the original image that has been subjected to the edge detection in step S9 (step S11). In the present embodiment, by removing streak-like noise that corresponds to the stain adhering to the sensor, or the like, processing is executed to prevent the noise from affecting subsequent processing. However, the present disclosure is not limited to such noise removal.

Next, the controller 75 extracts contour edge information of the original image, from which the noise has been removed in step S11 (step S13). Edge information is sequentially searched in the main scanning direction or the sub-scanning direction, and the first edge information and the last edge information are each extracted as the contour edge information. The contour edge information includes the feature points.

Next, the controller 75 detects the tilt on the basis of the contour edge information that has been extracted in step S13 (step S15). In the present embodiment, a histogram of shifted amounts of coordinate values of the contour edges on two scanning lines, which are separated by a predetermined number of lines, is generated to obtain the tilt corresponding to a shifted amount of a portion at a peak of the frequency of the histogram. More specifically, it is considered to obtain a tilt angle by a calculation of a tan (the shifted amount/the predetermined number of lines). However, the present disclosure is not limited to such a method.

Next, the controller 75 corrects the tilt of each of the feature points in the contour edge information, which has been extracted in step S13, on the basis of the tilt detected in step S15 (step S17). In the present embodiment, the edge information is rotated by a rotation matrix, but the present disclosure is not limited to this method.

Next, the controller 75 removes the feature points in the unnecessary edge information from the feature points, the tilts of which have been corrected in step S17, in the contour edge information (step S19). A detailed description thereon will be made below with reference to FIG. 9.

Finally, the controller 75 detects the document range on the basis of the contour edge information after the feature points in the unnecessary edge information are removed in step S19 (step S21). In the present embodiment, the document range is detected by obtaining a rectangular range that circumscribes the remaining contour edge information. However, the present disclosure is not limited to this method.

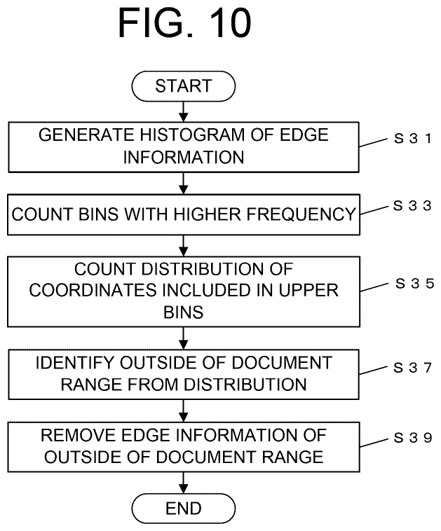

FIG. 10 is a flowchart illustrating removal of the unnecessary edge information in the action of the image processing apparatus 60 according to the first embodiment. The controller 75 generates a histogram of the edge information on the basis of the contour edge information, which has been subjected to the tilt correction in step S17 (step S31). Next, the controller 75 counts bins with the high frequency in the histogram generated in step S31 (step S33). Next, the controller 75 counts distribution of coordinates that are included in the bins with the high frequency counted in step S33 (step S35). Next, based on the distribution counted in step S35, the controller 75 identifies a coordinate range corresponding to the outside-of-the-document-range in a coordinate reference, which has been subjected to the tilt correction (step S37). The outside-of-the-document-range is identified on the basis of the contour edge information, which has been subjected to the tilt correction. Thus, when the document is tilted, the outside-of-the-document-range identified herein is also tilted. Next, the controller 75 removes the contour edge information, which is included in the outside-of-the-document-range identified in step S37 and has been subjected to the tilt correction (step S39).

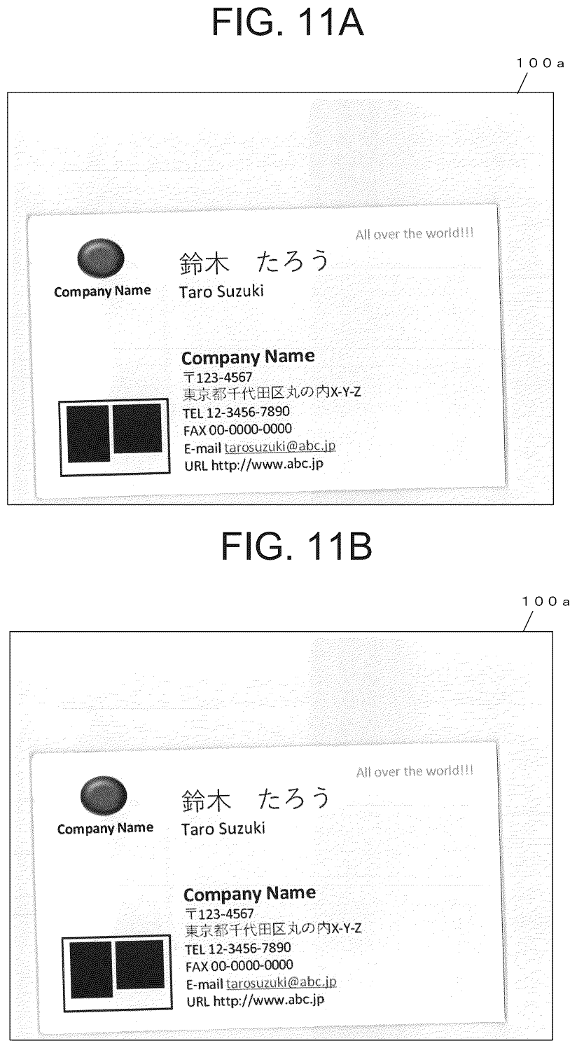

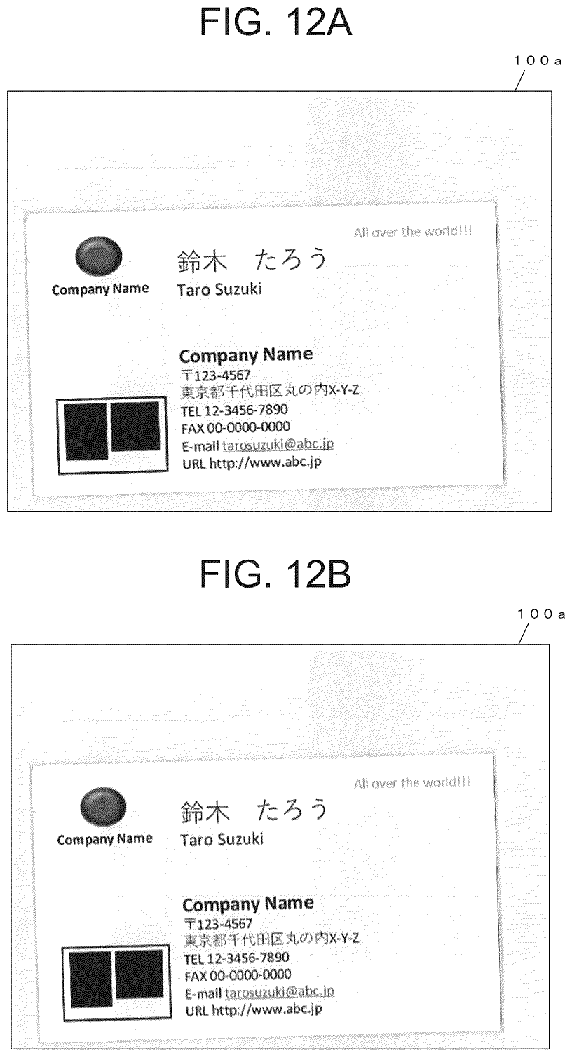

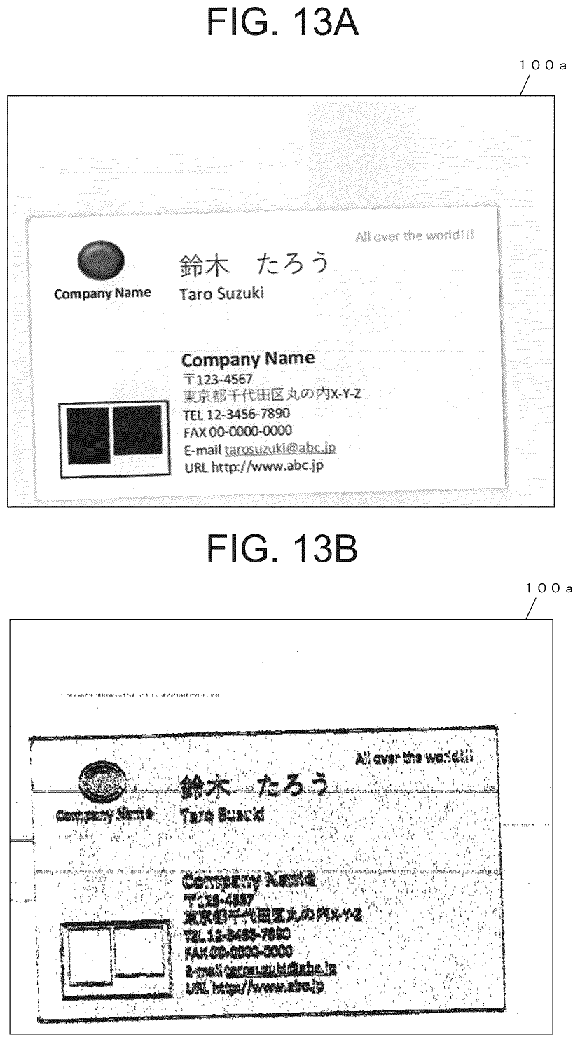

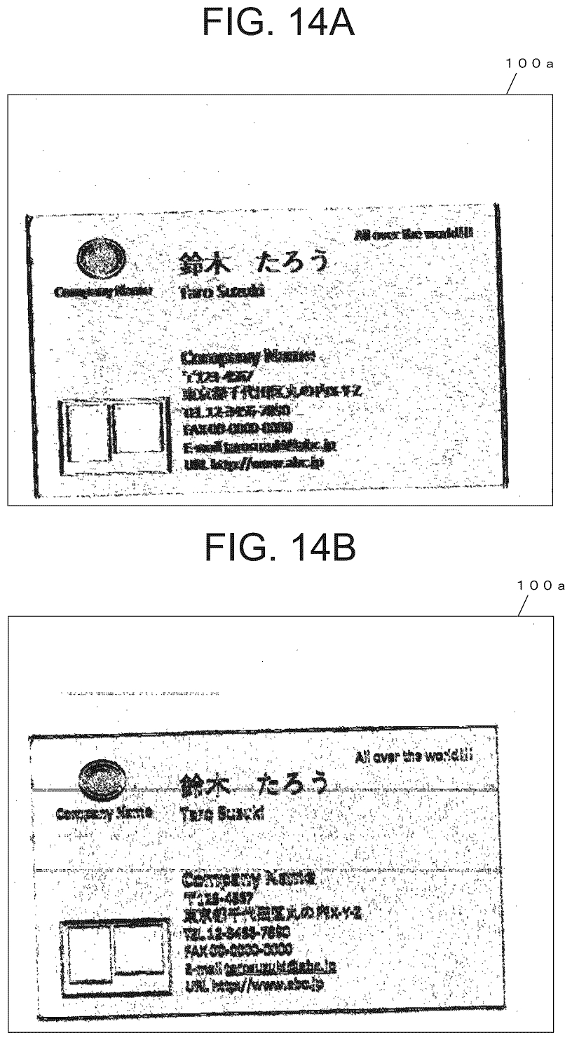

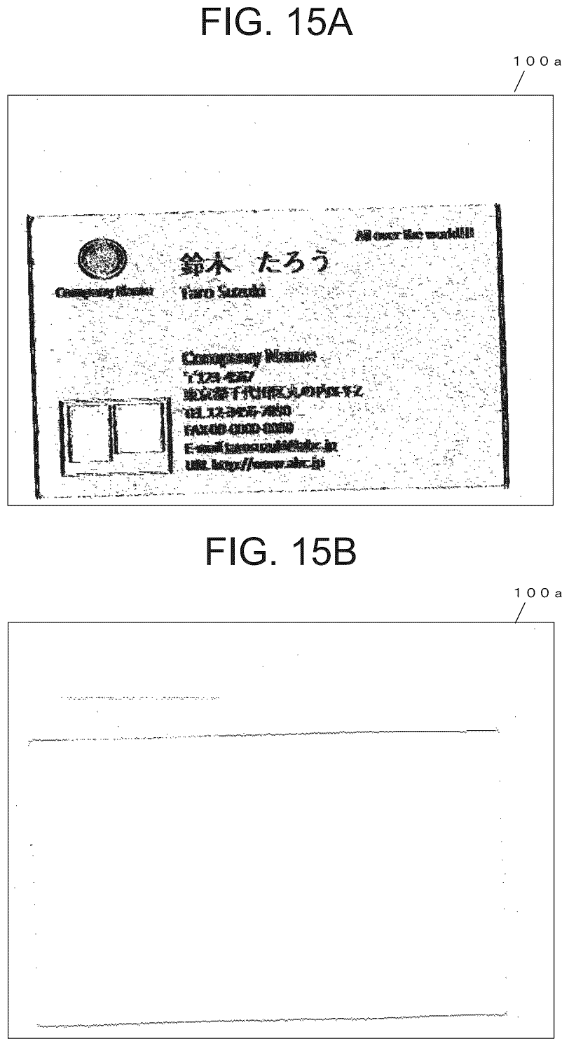

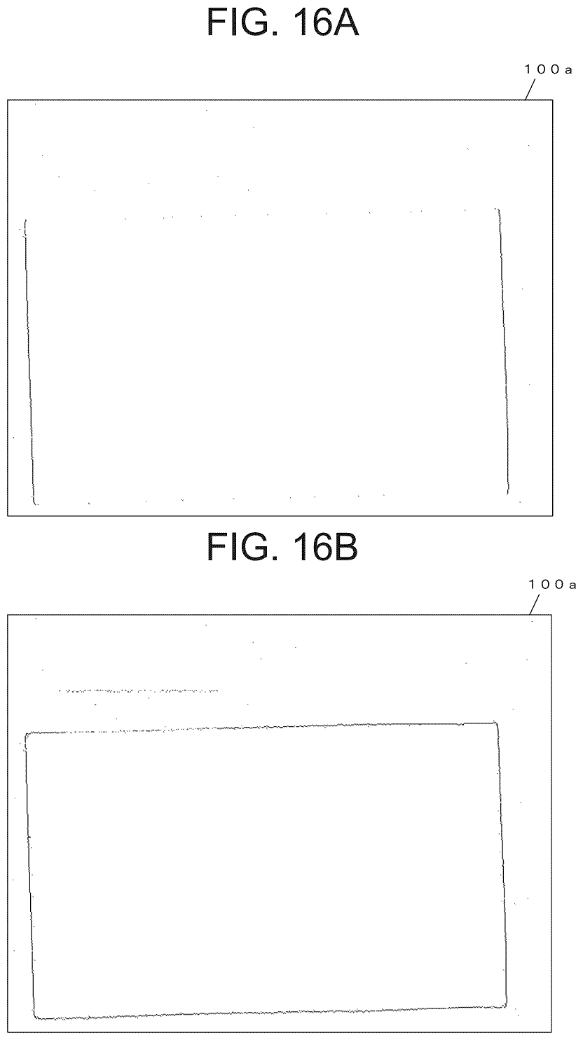

Examples of the original image subjected to the processing in steps S1 to S13 in FIG. 9 will be described. The following drawings each illustrate an example of the processing on the image in the case where the above-described processing is applied to the document 80. FIG. 11A is an example of the original image. FIG. 11B illustrates a state after the gradation of the original image in FIG. 11A is corrected in step S3. FIG. 12A illustrates a state after the original image in FIG. 12B is scaled in step S5. FIG. 12B illustrates a state after an edge in the horizontal direction of the original image in FIG. 12A is subjected to the filtering processing in step S7. FIG. 13A illustrates a state after an edge in the vertical direction of the original image in FIG. 12A is subjected to the filtering processing in step S7. FIG. 13B illustrates a state after the edge in the horizontal direction of the original image in FIG. 12B is detected in step S9. FIG. 14A illustrates a state after the edge in the vertical direction of the original image in FIG. 13A is detected in step S9. FIG. 14B illustrates a state after the noise in the horizontal direction of the original image in FIG. 13B is removed in step S11. FIG. 15A illustrates a state after the noise in the vertical direction of the original image in FIG. 14A is removed in step S11. FIG. 15B illustrates a state after the contour edge in the horizontal direction of the original image in FIG. 14B is subjected to the contour edge information extraction in step S13. FIG. 16A illustrates a state after the contour edge in the vertical direction of the original image in FIG. 15A is subjected to the contour edge information extraction in step S13. FIG. 16B illustrates a state where the contour edge in the horizontal direction in FIG. 15B and the contour edge in the vertical direction in FIG. 16A are combined and generated in step S13.

In the first embodiment and the example thereof described above, the description has been made that the feature points are extracted from the original image including the document image and that the document range and the outside-of-the-document-range of the original image are determined on the basis of those feature points. In this way, by determining the document range and the outside-of-the-document-range on the basis of the feature points, it is possible to reduce a necessary calculation amount. However, the document range and the outside-of-the-document-range may be determined not on the basis of the feature points but on the basis of the image data of the original image.

### 2. Second Embodiment

A second embodiment will be described. In the first embodiment, the document is drawn on the rectangular medium. The second embodiment differs from the first embodiment in that the document is not the rectangle but is a rectangle with four rounded corners, a so-called rounded rectangle. Hereinafter, a description will be centered only on differences in the configuration and the processing from those in the first embodiment.

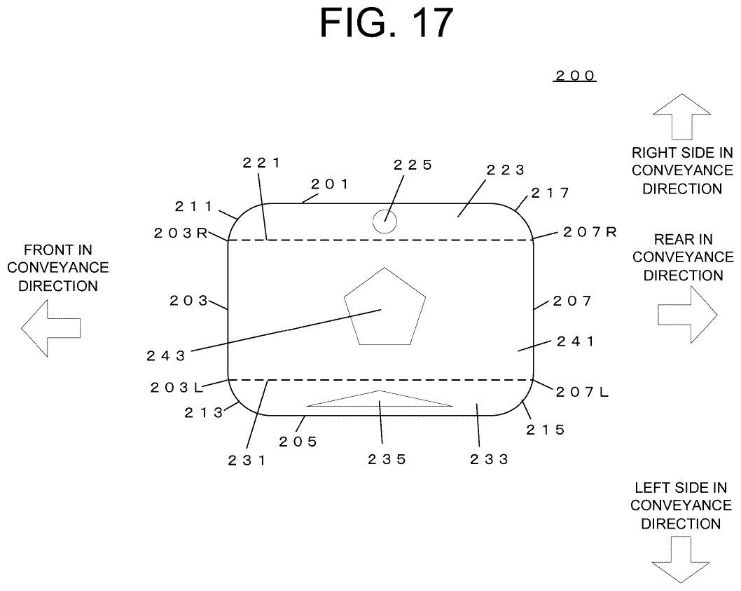

FIG. 17 is a view illustrating a shape of a document 200 that is used in the second embodiment of the present disclosure. Four sides of the document 200 are surrounded by line segments 201, 203, 205, 207. The line segment 203 is also referred to as a first side, and the line segment 207 is also referred to as a second side. The document 200 has a rectangular shape with rounded corners. The line segment 201 and the line segment 203 are connected by a rounded corner 211, the line segment 203 and the line segment 205 are connected by a rounded corner 213, the line segment 205 and the line segment 207 are connected by a rounded corner 215, and the line segment 207 and the line segment 201 are connected by a rounded corner 217. For convenience of the description, a radius of each of the rounded corners is set to be extremely large.

A dotted line 221 is a dotted line that is provided for the description, and may not be actually drawn. The dotted line 221 connects end points 203R, 207R on the right side in the conveyance direction of the line segment 203 and the line segment 207. Similarly, a dotted line 231 is a dotted line that is provided for the description, and may not be actually drawn. The dotted line 231 connects end points 203L, 207L on the left side in the conveyance direction of the line segment 203 and the line segment 207. An object 225 is drawn in an area 223 that is surrounded by the rounded corner 211, the line segment 201, the rounded corner 217, and the dotted line 221. Similarly, an object 235 is drawn in an area 233 that is surrounded by the rounded corner 213, the line segment 205, the rounded corner 215, and the dotted line 231. An object 243 is drawn in a rectangular area 241 that is surrounded by the dotted line 221, the line segment 203, the dotted line 231, and the line segment 207. Each of the objects 225, 235, 243 is a part or whole of an appropriate character, symbol, figure, image, or the like.

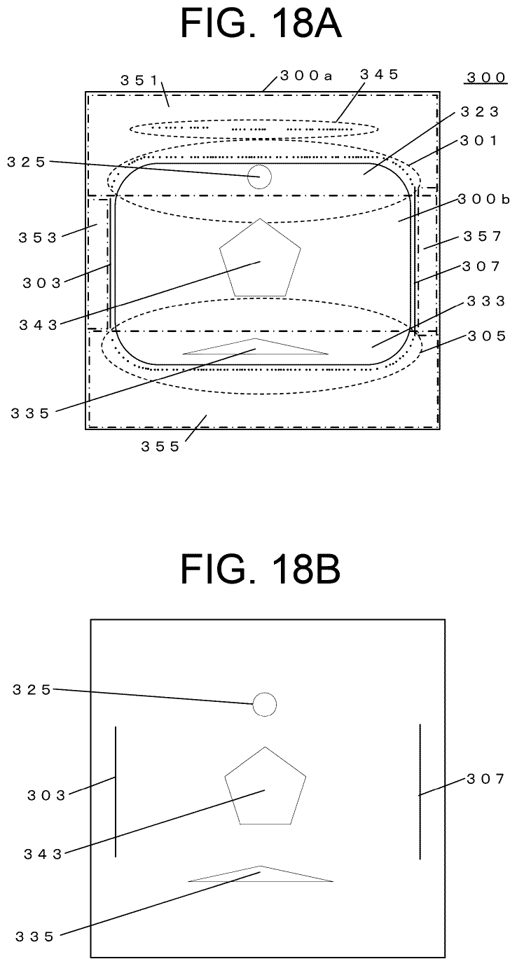

FIG. 18A is a view illustrating outsides-of-the-document range, which are determined by using the method in the first embodiment, in an original image 300 generated by capturing the image of the document 200 in FIG. 17. FIG. 18A includes the original image 300 and feature points that are extracted by executing the feature point extraction processing on the original image 300.

The original image 300 includes a white background 300a and a document image 300b. Each of feature point groups 301, 303, 305, 307 is a set of feature points that are extracted as feature points corresponding to an outer periphery of the document image 300b. The feature point group 301 corresponds to the rounded corner 211, the line segment 201, and the rounded corner 217 of the document 200. The feature point group 303 corresponds to the line segment 203 of the document 200. The feature point group 305 corresponds to the rounded corner 213, the line segment 205, and the rounded corner 215 of the document 200. The feature point group 307 corresponds to the line segment 207 of the document 200. An object 325 that corresponds to the object 225 of the document 200 is present in an area 323 that corresponds to the area 223 of the document 200. An object 335 that corresponds to the object 235 of the document 200 is present in an area 333 that corresponds to the area 233 of the document 200. A feature point group 345 is noise that is generated when the image of the document 200 is captured, and does not correspond to the document 200.

A case where the unnecessary edge information is removed from such an original image 300 in a similar manner to that in the first embodiment is considered. In this case, outsides-of-the-document-range 351, 353, 355, 357 are determined on the basis of the feature point groups 303, 307, and pixels in these outsides-of-the-document-range are removed. However, the outside-of-the-document-range 351 includes the feature point group 345, the feature point group 301, and the object 325, and the outside-of-the-document 355 includes the feature point group 305 and the object 335. Accordingly, the feature point groups 301, 305 are removed, and an image as illustrated in FIG. 18B is obtained. The feature point groups 301, 305 respectively correspond to sides surrounding the outside of the objects 325, 335 that should not be removed. In this image, an area including the objects 325, 335 is determined as an outside-of-the-document-range, and thus a desired result is not obtained.

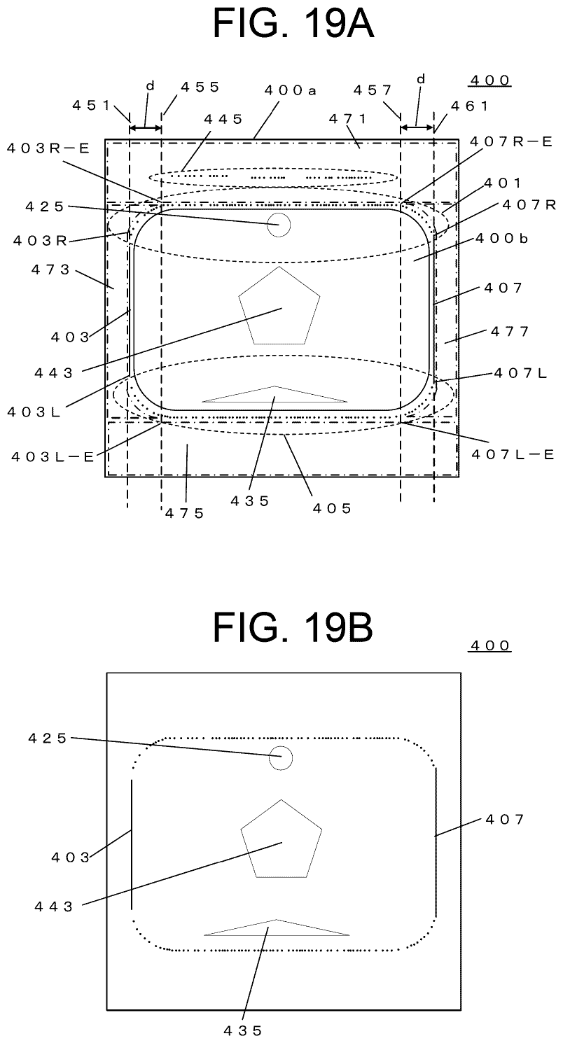

FIG. 19A is a view illustrating outsides-of-the-document range, which are determined by using the method in the second embodiment, in the original image generated by capturing the image of the document in FIG. 17. FIG. 19A includes an original image 400 and feature points that are extracted by executing the feature point extraction processing on the original image 400. The original image 400, which is generated by capturing the image of the document 200, includes a white background 400a and a document image 400b corresponding to the document 200. The white background 400a corresponds to the background of the document cover 65b. Each of feature point groups 401, 403, 405, 407 is a set of feature points that are extracted as corresponding to a contour edge of the document image 400b. The feature point group 401 corresponds to the rounded corner 211, the line segment 201, and the rounded corner 217. The feature point group 403 corresponds to the line segment 203. The feature point group 405 corresponds to the rounded corner 213, the line segment 205, and the rounded corner 215. The feature point group 407 corresponds to the line segment 207. Objects 425, 443, 435 correspond to the objects 225, 243, 235, respectively. A feature point group 445 is noise that is generated when the image is captured by the image input device 65, and does not correspond to the document 200.

In the case where the outside-of-the-document-range is determined, in the second embodiment, instead of using the feature point groups 403, 407 as they are as sides of a rectangle defining the outside-of-the-document-range, the outside-of-the-document-range is determined after each of the feature point groups 403, 407 is expanded as follows.

A dotted line 451 is a straight line that is formed by extending the line segment formed by the feature point group 403. The controller 75 obtains a dotted line 455 that is a straight line parallel to the dotted line 451 and is separated from the dotted line 451 by a distance d. The dotted line 455 is also referred to as a first virtual straight line. The distance d is about 1 to 10 mm, for example, and is preferably about 5 mm. The controller 75 determines the feature points between the dotted line 451 and the dotted line 455 as a part of the feature point group 403. In this way, feature points that extend from end points 403R, 403L of the feature point group 403 on the right side and the left side in the conveyance direction are determined as a part of the feature point group 403, and the feature point group 403 is thereby expanded. The expanded feature point group 403 has a shape that is formed by connecting an arc bent rearward in the conveyance direction to each of the end points 403R, 403L of the line segment formed by the original feature point group, and thus has a substantially arcuate shape. Similarly, the controller 75 obtains a dotted line 461, which is formed by extending the line segment formed by the feature point group 407, and a dotted line 457 (a second virtual straight line) that is separated forward in the conveyance direction from the dotted line 461 by the distance d, determines feature points between the dotted line 461 and the dotted line 457 as a part of the feature point group 407, and thereby expands the feature point group 407. The expanded feature point group 407 has a shape that is formed by connecting an arc bent forward in the conveyance direction to each of end points 407R, 407L of the line segment corresponding to the original feature point group 407, and thus has a substantially arcuate shape.

The controller 75 determines, as an outside-of-the-document-range 471, a straight line connecting end points 403R-E, 407R-E of the expanded feature point groups 403, 407 on a right side in the conveyance direction and a rectangular area, which is located on the right side of this straight line in the conveyance direction, in the original image 400. The controller 75 determines, as an outside-of-the-document-range 473, the expanded feature point group 403 and an area, which is located in front of the expanded feature point group 403 in the conveyance direction, in the original image 400. The controller 75 determines, as an outside-of-the-document-range 475, a straight line connecting end points 403L-E, 407L-E on a left side in the conveyance direction of the expanded feature point groups 403, 407 and an area, which is located on the left side of this straight line in the conveyance direction, in the original image 400. The controller 75 determines, as an outside-of-the-document-range 477, the expanded feature point group 407 and an area, which is located behind the expanded feature point group 407 in the conveyance direction, in the original image 400.

FIG. 19B is a view illustrating a state where the unnecessary edge information in the second embodiment is removed from the original image 400 in FIG. 19A. The controller 75 removes the feature points in the outsides-of-the-document-range 471, 473, 475, 477. According to the second embodiment, the feature point group 445 that corresponds to the noise is removed. However, since the outsides-of-the-document-range 471, 473, 475, 477 are obtained by expanding the line segments formed by the feature point groups 403, 407. Thus, it is determined that the objects 425, 435 are located within the document range.

### 3. Third Embodiment

A third embodiment will be described. In the first embodiment, the unnecessary edge information is removed after the tilt of the edge is corrected. Meanwhile, in the third embodiment, the unnecessary edge information is removed without correcting the tilt of the edge. Here, a description will be centered only on differences in the configuration and the processing from those in the first embodiment.

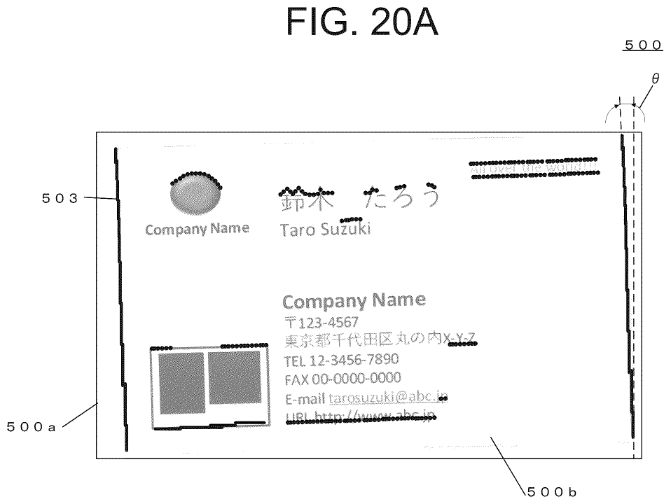

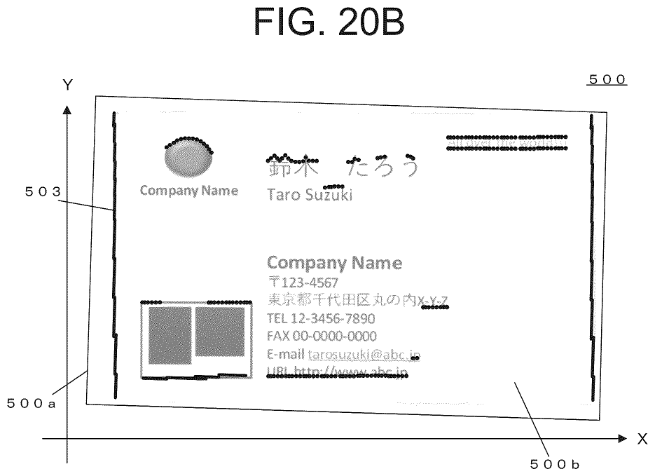

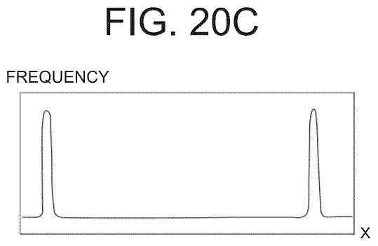

First, a description will be made on the method in the first embodiment, that is, the method for removing the unnecessary edge information after correcting the tilt of the edge. FIG. 20A illustrates an original image 500, a tilt of which is detected in step S15 after steps S1 to S13 in FIG. 9, and an example of feature point groups extracted from the original image 500. As illustrated in FIG. 20A, in the original image 500, a document image 500b of the business card is generated in a state of being arranged obliquely upward to the right in a white background 500a. In step S15, an angle at which the document is tilted is obtained. For example, the controller 75 calculates the tilt angle θ between the main scanning direction and a line segment that is formed by a feature point group 503 along a direction substantially orthogonal to the conveyance direction, that is, substantially along the main scanning direction.

FIG. 20B illustrates a state where the original image 500 and the feature point group 503 in FIG. 20A are subjected to the tilt correction of the edge information that uses the tilt angle θ obtained in step S15. As illustrated in FIG. 20B, as a result of correction of the tilt angle θ, the line segment formed by the feature point group 503 is along the direction orthogonal to the conveyance direction (the main scanning direction). Here, the main scanning direction is set as a Y-axis direction, and the sub-scanning direction is set as an X-axis direction. FIG. 20C illustrates an example of a histogram of a vertical edge that is generated on the basis of the feature point group 503, which has been subjected to the tilt correction of the edge information, in FIG. 20B. When generating the histogram of the edge information in step S31 of FIG. 10, in FIG. 20B, the controller 75 obtains a straight line that is parallel to the Y-axis at each point on the X-axis. Then, the controller 75 counts the pixels (the feature points) on each of the straight lines to generate bins and the histogram.

In the first embodiment, the rotation for correcting the tilt angle θ has to be calculated for all the feature points on the original image 500. As a result, a calculation amount is increased.

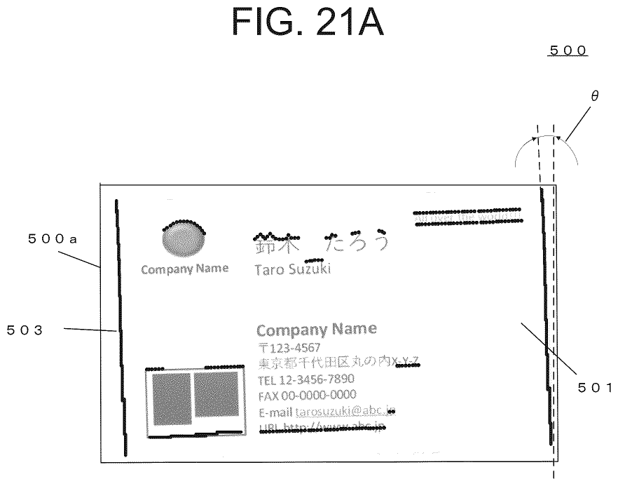

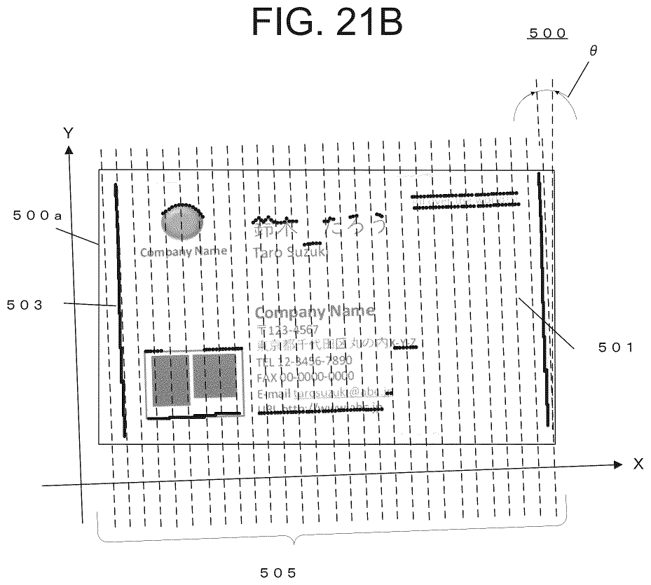

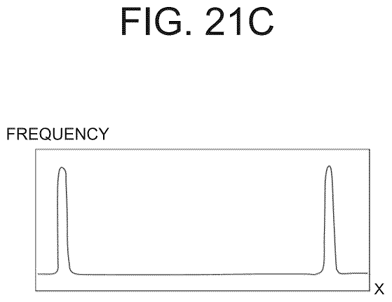

Next, a method in the third embodiment will be described. In the third embodiment, the processing in step S17 of FIG. 9 is not executed. Instead, when the histogram of the vertical edge is generated in step S19, a straight line group 505 having the tilt angle θ, which is obtained in step S15, is obtained from the original image 500 in FIG. 21A. Straight lines in the straight line group 505 are each arranged to match the respective feature point group. The straight line group 505 is exemplified in FIG. 21B. The feature points on each of the straight lines in the straight line group 505 are counted to generate bins and a histogram. As illustrated in FIG. 21C, also in the third embodiment, the histogram that is similar to the histogram in the first embodiment illustrated in FIG. 20C can be obtained. At this time, unlike the first embodiment, there is no need to calculate the rotation of the feature points. Thus, the calculation amount can be suppressed.

### 4. Modified Examples

The present disclosure is not limited to the embodiments and variations described above, and various modifications may be made thereto. In other words, embodiments to be obtained by combining technical measures modified as appropriate within a range that does not depart from the gist of the present disclosure are also included in the technical scope of the present disclosure.

The program, which is operated in each of the devices in the embodiments, is a program that controls the CPU and the like (a program that causes a computer to function) to implement the functions in the above-described embodiments. The information to be handled by each of these devices is temporarily accumulated in a temporary storage device (for example, RAM) during processing of the information, is then stored in any of various storage devices such as read only memory (ROM) and an HDD, and is read, corrected, or written by the CPU when necessary.

Here, a recording medium that stores the program may be any of a semiconductor medium (for example, the ROM, a non-volatile memory card, or the like), an optical recording medium/magneto-optical recording medium (for example, a digital versatile disc (DVD), a magneto optical disc (MO), a mini disc (MD), a compact disc (CD), a Blu-ray® disc (BD), or the like), and a magnetic recording medium (for example, a magnetic tape, a flexible disk, or the like). In addition, the functions in the above-described embodiments are implemented not only by executing the loaded program, but the functions in the present disclosure may also be implemented by processing in collaboration with an operating system, another application program, or the like, on the basis of the instruction of the program.

Furthermore, in the case where the program is distributed to the market, the program may be stored in a portable recording medium for distribution or transferred to a server computer connected via a network such as the Internet. In this case, needless to say, a storage device of the server computer is also included in the present disclosure.

What is claimed is:

1. An image processing apparatus comprising:
a controller, wherein
the controller:
obtains an image that is obtained by reading a document;
extracts a feature point from the image;
identifies a plurality of feature points arranged in a predetermined direction in the image as feature points that correspond to an edge defining a range of the document;
sets an area outside the range of the document on the basis of the identified feature points; and
removes the feature points in the set area.

2. The image processing apparatus according to claim 1, wherein
the image is generated by using a line image sensor and light source element groups, a plurality of imaging elements being arranged along a first straight line in the line image sensor, and the light source element groups being arranged along a second straight line that is orthogonal to the first straight line, and
the predetermined direction is parallel to the second straight line.

3. The image processing apparatus according to claim 2, wherein
the feature points that correspond to the edge includes feature points that correspond to two sides of the document, the two sides being substantially parallel to the first straight line.

4. The image processing apparatus according to claim 3, wherein
when the two sides of the document that are substantially parallel with the first straight line are a first side and a second side, and
in the image, straight lines that are separated from the feature points corresponding to the first side and the second side and that are parallel to the first side and the second side are a first virtual straight line and a second virtual straight line,
the feature points that correspond to a part of the edge further include: feature points between a straight line obtained by extending the first side and the first virtual straight line; and feature points between a straight line obtained by extending the second side and the second virtual straight line.

5. The image processing apparatus according to claim 1 further comprising:
an image input device, wherein
the image input device includes a background portion that serves as a background of the document when the image input device captures the image of the document, and
the image includes a background image corresponding to the background portion and a document image corresponding to the document.

6. The image processing apparatus according to claim 5, wherein
the background is white.

7. The image processing apparatus according to claim 1, wherein
the controller:
calculates coordinates of the feature points extracted from the image; and
extracts the feature points that correspond to a part of the edge defining the document range on the basis of the coordinates.

8. The image processing apparatus according to claim 1, wherein
the controller:
identifies pixels of the feature points extracted from the image; and
extracts the feature points that correspond to a part of the edge defining the document range on the basis of the pixels.

9. A control method for an image processing apparatus comprising:
obtaining an image that is obtained by reading an image;
extracting a feature point from the image;
identifying a plurality of feature points arranged in a predetermined direction in the image as feature points that correspond to an edge defining a range of the document;
setting an area outside the range of the document on the basis of the identified feature points; and
removing the feature points in the set area.
